(19) United States
(12) Patent Application Publication
(10) Pub. No.: US 2026/0290666 A1
(43) Pub. Date: Sep. 24, 2026

(54) SOFT MAGNETIC POWDER, MAGNETIC AND COIL DEVICE

(71) Applicant: TDK Corporation, Tokyo (JP)

(72) Inventors: Shota OTSUKA, Tokyo (JP); Masashi ITO, Tokyo (JP)

(73) Assignee: TDK Corporation, Tokyo (JP)

(21) Appl. No.: 19/569,130

(22) Filed: Mar. 17, 2026

(30) Foreign Application Priority Data
Mar. 19, 2025 (JP) 2025-045478
Jan. 30, 2026 (JP) 2026-014884

(51) Int. Cl. H01F 1/36; B22F 1/00; B22F 1/052; B22F 1/12; H01F 1/34

(52) U.S. Cl. CPC H01F 1/36; B22F 1/052; B22F 1/09; B22F 1/12; H01F 1/344; B22F 2301/15; B22F 2301/35; B22F 2304/10; B22F 2999/00

(57) ABSTRACT

A soft magnetic powder and a magnetic body each include a large-diameter metal powder, a small-diameter metal powder, and a ferrite powder. The large-diameter metal powder includes large-diameter powder particles having a particle size of 1.0 μm or more. The small-diameter metal powder includes small-diameter powder particles having a particle size of less than 1.0 μm. The ferrite powder includes ferrite powder particles having a particle size of 1.0 μm or more. The ferrite powder includes a Ni-based ferrite powder. A soft magnetic alloy powder having a composition represented by the composition formula (Fe₁₋ₚX1ₚ)_{100-(a+b+c+d+e)}BₐP_{b}Si_{c}C_{d}X2ₑ in atomic ratio.

### BACKGROUND OF THE INVENTION

The present disclosure relates to a soft magnetic powder, a magnetic body, and a coil device.

### BACKGROUND

Patent Document 1 discloses an invention relating to a coil device and to a resin containing metal magnetic powder. A resin containing metal magnetic powder, including three types of metal powder particles having mutually different average particle sizes, is used in a coil device, whereby the coil device exhibits improved inductance while core loss is not significantly increased.

### PRIOR ART DOCUMENT

### Patent Document

Patent Document 1: JP Patent Application Laid Open No. 2014-060284

### BRIEF SUMMARY OF THE INVENTION

### Means for Solving the Problem

A soft magnetic powder of an exemplary embodiment of the present disclosure includes:
a large-diameter metal powder;
a small-diameter metal powder; and
a ferrite powder,
wherein the large-diameter metal powder includes large-diameter powder particles having a particle size of 1.0 μm or more,
the small-diameter metal powder includes small-diameter powder particles having a particle size of less than 1.0 μm,
the ferrite powder includes ferrite powder particles having a particle size of 1.0 μm or more, and
the ferrite powder includes a Ni-based ferrite powder.

A magnetic body of an exemplary embodiment of the present disclosure includes:
a large-diameter metal powder;
a small-diameter metal powder; and
a ferrite powder,
wherein the large-diameter metal powder includes large-diameter powder particles having a particle size of 1.0 μm or more,
the small-diameter metal powder includes small-diameter powder particles having a particle size of less than 1.0 μm,
the ferrite powder includes ferrite powder particles having a particle size of 1.0 μm or more, and
the ferrite powder includes a Ni-based ferrite powder.

### BRIEF DESCRIPTION OF THE SEVERAL VIEWS OF THE DRAWING

FIG. 1 is a schematic diagram of a magnetic body.

FIG. 2 is a SEM image of a cross section of a magnetic body.

### DETAILED DESCRIPTION OF THE INVENTION

An object of the present disclosure is to provide a soft magnetic powder and a magnetic body having high initial permeability and low permittivity, and capable of providing excellent DC bias characteristics when used in a coil device.

In the soft magnetic powder according to the present disclosure, the average particle size of the ferrite powder particles may be larger than that of the large-diameter powder particles.

In the soft magnetic powder according to the present disclosure, the large-diameter metal powder may include a first large-diameter metal powder and a second large-diameter metal powder, and
the average particle size of first large-diameter powder particles included in the first large-diameter metal powder may be larger than that of second large-diameter powder particles included in the second large-diameter metal powder.

In the soft magnetic powder according to the present disclosure, the average particle size of the ferrite powder particles may be larger than that of the first large-diameter powder particles.

In the soft magnetic powder according to the present disclosure, the content of the ferrite powder may be larger than that of the second large-diameter metal powder on a weight basis.

In the soft magnetic powder according to the present disclosure, the content of the ferrite powder may be 50 wt % or less.

In the magnetic body according to the present disclosure, the average particle size of the ferrite powder particles may be larger than that of the large-diameter powder particles.

In the magnetic body according to the present disclosure, the large-diameter metal powder may include a first large-diameter metal powder and a second large-diameter metal powder, and
the average particle size of first large-diameter powder particles included in the first large-diameter metal powder may be larger than that of second large-diameter powder particles included in the second large-diameter metal powder.

In the magnetic body according to the present disclosure, the average particle size of the ferrite powder particles may be larger than that of the first large-diameter powder particles.

In the magnetic body according to the present disclosure, the total area ratio of the ferrite powder particles may be larger than that of the second large-diameter powder particles in a cross section of the magnetic body.

In the magnetic body according to the present disclosure, the total area ratio of the ferrite powder particles may be 50 wt % or less.

A coil device according to the present disclosure includes the soft magnetic powder.

A coil device according to the present disclosure includes the magnetic body.

Hereinafter, embodiments of the present disclosure will be described. The present disclosure is not limited to the embodiments described herein and may be implemented with appropriate modifications, changes, or alterations within the spirit and scope of the present disclosure. In addition, descriptions of portions that are repetitive may be omitted as appropriate, but such omission does not limit the spirit and scope of the present disclosure.

A coil device according to an exemplary embodiment of the present disclosure includes a magnetic core and a coil. The magnetic core includes a magnetic body 1. The magnetic body 1 may include the soft magnetic powder described below.

The soft magnetic powder according to an exemplary embodiment of the present disclosure includes a large-diameter metal powder, a small-diameter metal powder, and a ferrite powder. The large-diameter metal powder includes large-diameter powder particles having a particle size of 1.0 μm or more. The small-diameter metal powder includes small-diameter powder particles having a particle size of less than 1.0 μm. The ferrite powder includes ferrite powder particles having a particle size of 1.0 μm or more and is a Ni-based ferrite powder.

The Ni-based ferrite powder refers to a ferrite powder containing oxides of Ni and oxides of Fe as main components. The oxides of Ni may be simple oxides of Ni or composite oxides containing Ni. The oxides of Fe may be simple oxides of Fe or composite oxides containing Fe.

The type of Ni-based ferrite is not particularly limited. For example, Ni ferrite, Ni—Zn ferrite, or Ni—Cu—Zn ferrite may be used.

The large-diameter metal powder may have any composition. For example, the large-diameter metal powder may be permalloy powder, iron powder, amorphous alloy powder, or nanocrystalline powder.

The small-diameter metal powder may have any composition. For example, the small-diameter metal powder may be permalloy powder, iron powder, amorphous alloy powder, or nanocrystalline powder.

The permalloy powder may contain Ni in an amount of 30 wt % or more and 80 wt % or less and Fe in an amount of 20 wt % or more and 70 wt % or less. The iron powder may contain Fe in an amount of 90 wt % or more and 100 wt % or less.

The average particle size of the ferrite powder particles may be larger than that of the large-diameter powder particles.

The average particle size of the ferrite powder particles may be 1.0 μm or more and 50 μm or less, or 20 μm or more and 50 μm or less. The average particle size of the large-diameter powder particles may be 10 μm or more and 40 μm or less. The average particle size of the small-diameter powder particles may be 0.2 μm or more and less than 1.0 μm, or 0.3 μm or more and 0.9 μm or less.

The ferrite powder may be included in the soft magnetic powder in an amount of 5 wt % or more and 80 wt % or less, or 30 wt % or more and 50 wt % or less. The large-diameter powder particles may be included in an amount of 10 wt % or more and 80 wt % or less, or 30 wt % or more and 50 wt % or less. The small-diameter powder particles may be included in an amount of 5 wt % or more and 30 wt % or less.

Furthermore, the large-diameter metal powder may include a first large-diameter metal powder and a second large-diameter metal powder. The average particle size of first large-diameter powder particles included in the first large-diameter metal powder is larger than that of second large-diameter powder particles included in the second large-diameter metal powder.

The average particle size of the ferrite powder particles may be larger than that of the first large-diameter powder particles.

The average particle size of the first large-diameter powder particles may be 10 μm or more and 40 μm or less. The average particle size of the second large-diameter powder particles may be 1 μm or more and 10 μm or less.

The first large-diameter metal powder and the second large-diameter metal powder may have any composition. For example, the first large-diameter metal powder may be permalloy powder, and the second large-diameter metal powder may be iron powder.

The content of each powder included in the soft magnetic powder is not particularly limited, but the content of the ferrite powder may be larger than that of the second large-diameter metal powder. The ratio of the content of the ferrite powder to the content of the second large-diameter metal powder may be 2 or more and 5 or less, or 3 or more and 5 or less. The ferrite powder may be included in an amount of 50 wt % or less. When the content of the ferrite powder satisfies these conditions, the permittivity is more likely to decrease.

The first large-diameter powder particles may be included in the soft magnetic powder in an amount of 30 wt % or more and 50 wt % or less, or 35 wt % or more and 40 wt % or less. The second large-diameter powder particles may be included in an amount of 0 wt % or more and 25 wt % or less, or 10 wt % or more and 20 wt % or less.

Each of the above-described powder particles may have a coating on its surface. The coating may be an insulating coating. The coating may be of any type that is formed by a coating method normally used in this technical field. Examples of such coatings include iron-based oxides, phosphates, silicates (water glass), soda-lime glass, borosilicate glass, lead glass, aluminosilicate glass, borate glass, and sulfate glass. Examples of phosphates include magnesium phosphate, calcium phosphate, zinc phosphate, manganese phosphate, and cadmium phosphate. Examples of silicates include sodium silicate. The coating may have any thickness. The coating may have an average thickness of, for example, 5 nm or more and 100 nm or less.

The soft magnetic powder has high initial permeability and low permittivity and is capable of providing excellent DC bias characteristics when used in a coil device.

The magnetic body according to an exemplary embodiment of the present disclosure includes a large-diameter metal powder, a small-diameter metal powder, and a ferrite powder. The large-diameter metal powder includes large-diameter powder particles having a particle size of 1.0 μm or more. The small-diameter metal powder includes small-diameter powder particles having a particle size of less than 1.0 μm. The ferrite powder includes ferrite powder particles having a particle size of 1.0 μm or more and is a Ni-based ferrite powder. That is, the magnetic body of the exemplary embodiment of the present disclosure may include the above-described soft magnetic powder.

The composition of each powder and the average particle size of powder particles of each powder included in the magnetic body are as described above.

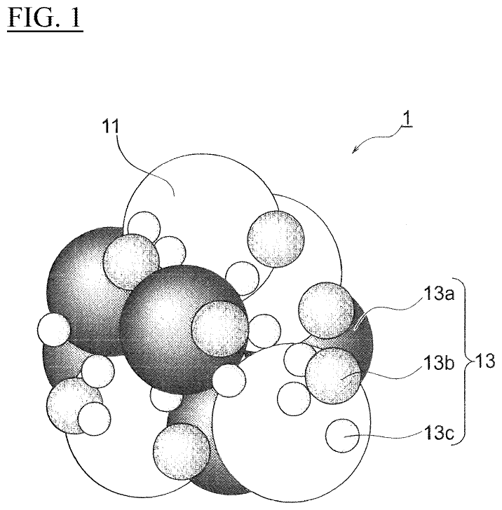

FIG. 1 is a schematic diagram illustrating a three-dimensional configuration of powder particles included in a magnetic body 1 of an exemplary embodiment of the present disclosure. As shown in FIG. 1, the magnetic body 1 is a mixture of ferrite powder particles 11 and metal powder particles 13. The metal powder particles 13 include first large-diameter powder particles 13a, second large-diameter powder particles 13b, and small-diameter powder particles 13c. A resin or other components may be present between the powder particles.

The magnetic body 1 of the exemplary embodiment of the present disclosure is obtained by changing the material of some large-diameter powder particles of an existing magnetic body to Ni-based ferrite. Compared with a magnetic body that does not include a Ni-based ferrite powder, the magnetic body including the Ni-based ferrite powder in part has high initial permeability and low permittivity and is capable of providing excellent DC bias characteristics when used in a coil device.

The method for observing the soft magnetic particles included in the magnetic body 1 is not particularly limited. For example, a method of observing a cross section of the magnetic body 1 using SEM, TEM, or the like may be used. A cross section obtained by cutting the magnetic body 1 may be polished.

The size of the field of view for observing a cross section of the magnetic body 1 is not particularly limited. The field of view is determined such that it includes 10000 or more soft magnetic particles in total. One field of view or a plurality of adjacent fields of view may be set, or a plurality of fields of view may be set at positions separate from each other.

The magnification and resolution for observing a cross section of the magnetic body 1 are not particularly limited. The magnification may be from 500× to 3000×, and the resolution may be 2560×1920 pixels or greater.

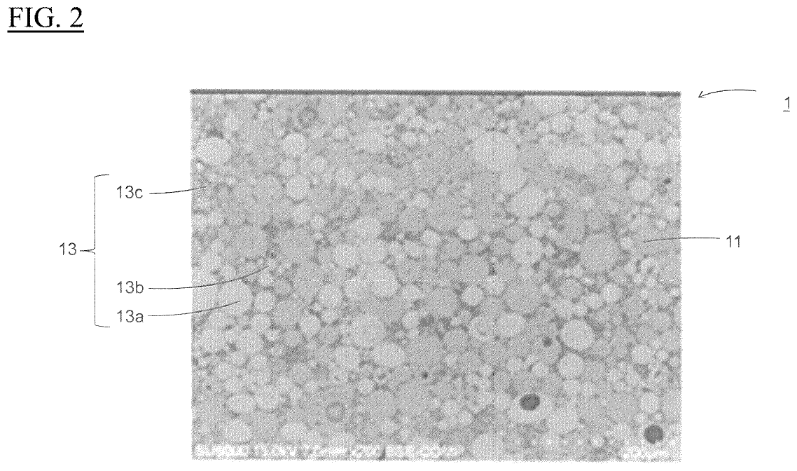

FIG. 2 shows an example of a SEM image (bright-field image) of a cross section of the magnetic body 1 of the exemplary embodiment of the present disclosure. The magnetic body 1 includes ferrite powder particles 11 and metal powder particles 13. In the bright-field image, the ferrite powder particles 11 appear darker than the metal powder particles 13 and can therefore be distinguished therefrom. The ferrite powder particles 11 include many relatively large particles, whereas the metal powder particles 13 include many small particles as well as many large particles. Most of the relatively large particles are derived from the large-diameter metal powder (in particular, the first large-diameter metal powder). Most of the relatively small particles are derived from the small-diameter metal powder and the second large-diameter metal powder.

The method for distinguishing the first large-diameter powder particles 13a, the second large-diameter powder particles 13b, and the small-diameter powder particles 13c in a cross section of the magnetic body 1 is not particularly limited. When these powder particles have compositions different from each other, they can be distinguished using EDS or the like. When the materials of these powder particles are the same, the equivalent circular diameter of each powder particle included in a cross section is measured, and the distribution of the equivalent circular diameter is determined, whereby the powder particles may be distinguished. When the powder particles have different sphericity, they may be distinguished based on the aspect ratios of the respective powder particles in a cross section.

The equivalent circular diameter of a particle in a cross section of the magnetic body 1 is represented by (4S/π)^{1/2}, where S denotes the area of the particle in the cross section.

The average particle size of ferrite powder particles used in manufacturing the magnetic body 1 shown in FIG. 2 is larger than that of the first large-diameter powder particles. However, as shown in FIG. 2, there appears to be no significant difference in the average equivalent circular diameter or the average area per particle between the ferrite powder particles 11 and the first large-diameter powder particles 13a. This is because the width of the particle size distribution of the ferrite powder particles is narrower than that of the first large-diameter powder particles.

In a cross section of the magnetic body 1, the average equivalent circular diameter of the ferrite powder particles 11 may be larger than that of the first large-diameter powder particles 13a.

In a cross section of the magnetic body 1, the total area ratio of the ferrite powder particles 11 may be larger than that of the second large-diameter powder particles 13b.

In a cross section of the magnetic body 1, the total area ratio of the ferrite powder particles 11 may be larger than that of the first large-diameter powder particles 13a.

The total area ratio of the ferrite powder particles 11 in a cross section of the magnetic body 1 may be 50% or less.

In a cross section of the magnetic body 1, the average circularity of the ferrite powder particles 11 may be smaller than that of the metal powder particles 13. In the present embodiment, the circularity of a particle is calculated by dividing the circumference of a circle having the same area as the particle by the perimeter of the particle.

In a cross section of the magnetic body 1, the number of ferrite powder particles 11 having an equivalent circular diameter of 20 μm or more may be greater than that of metal powder particles 13 having an equivalent circular diameter of 20 μm or more. In addition, the proportion of ferrite powder particles 11 having an equivalent circular diameter of 20 μm or more among all ferrite powder particles 11 and metal powder particles 13 each having an equivalent circular diameter of 20 μm or more may be 50% or more.

The magnetic body according to an exemplary embodiment of the present disclosure may include resin in addition to the metal powder and the ferrite powder. The resin may be of any type. Examples of resins include silicone resin and epoxy resin. The content of resin is not particularly limited. For example, on the basis that the total content of the metal powder and the ferrite powder is 100 parts by weight, the resin content may be 1.0 parts by weight or more and 5.0 parts by weight or less, or 1.5 parts by weight or more and 3.5 parts by weight or less. As the resin content increases, the packing density of the soft magnetic powder tends to decrease, and the permeability also tends to decrease. If the packing density of the soft magnetic powder is increased to improve the permeability, the DC bias characteristics of a coil device including the magnetic body tends to decrease.

In a cross section of the magnetic body 1, the portion other than the metal powder and the ferrite powder may be occupied by resin or by resin and voids.

A coil device according to an exemplary embodiment of the present disclosure includes the soft magnetic powder. The soft magnetic powder may be included in a magnetic core. Other components are not particularly limited.

A coil device according to an exemplary embodiment of the present disclosure includes the magnetic body. The magnetic body may be used as a magnetic core. Other components are not particularly limited.

A non-limiting example of a method for manufacturing a magnetic body using the soft magnetic powder according to an exemplary embodiment of the present disclosure is described below.

First, a soft magnetic powder of an exemplary embodiment of the present disclosure is prepared. The soft magnetic powder of the exemplary embodiment of the present disclosure can be obtained by mixing the ferrite powder, the large-diameter metal powder, and the small-diameter metal powder described above. Hereinafter, a case in which both the first large-diameter metal powder and the second large-diameter metal powder are used as the large-diameter metal powder will be described.

The methods for preparing the ferrite powder, the first large-diameter metal powder, the second large-diameter metal powder, and the small-diameter metal powder are not particularly limited. Each of the metal powders may be prepared by known methods such as atomizing, liquid-phase, spray pyrolysis, and melting methods, or by pulverizing a starting metal material. For example, the ferrite powder may be obtained as follows. Metal oxide powders are prepared as raw material powders, and the raw material powders are mixed. The mixture is calcined in air, and the calcined mixture is pulverized to obtain the ferrite powder. Alternatively or additionally, a commercially available powder may simply be used for each type of powder.

The average particle size of each of the metal powders and/or the ferrite powder may be controlled by appropriately removing coarse and/or fine particles using an airflow classifier.

Each of the metal powders and/or the ferrite powder may be provided with a coating at this stage. Any method of forming the coating may be used.

The metal powders and the ferrite powder are then mixed to obtain the soft magnetic powder of the exemplary embodiment of the present disclosure. The metal powders and the ferrite powder may be weighed to control their respective contents at this stage.

Next, a magnetic body is manufactured using the soft magnetic powder.

First, the soft magnetic powder and resin are kneaded to prepare a resin compound. Based on 100 parts by weight of the soft magnetic powder in the resin compound, the resin content may be 1.0 parts by weight or more and 5.0 parts by weight or less, or 1.5 parts by weight or more and 3.5 parts by weight or less. As the resin content decreases, compression molding of the soft magnetic powder tends to become more difficult. Moreover, the strength of the magnetic body obtained by compression molding the soft magnetic powder tends to decrease, thereby making the magnetic body difficult to handle.

The obtained resin compound is placed in a mold and is subjected to compression molding to obtain a magnetic body. Compression molding may be carried out at any molding pressure. For example, the molding pressure may be 100 MPa or more and 280 MPa or less. Optionally, the resin in the obtained magnetic body may be cured by heating.

The compositions of particles in each powder before compression molding are generally the same as those of particles in the magnetic body after compression molding.

The magnetic body according to the exemplary embodiment of the present disclosure has been described above; however, it is not limited thereto.

For example, the magnetic body may be obtained by the above-described method, or may be obtained as a magnetic sheet by a printing method. The obtained magnetic sheet may be used as a magnetic core.

Specifically, a resin solution containing the above-described soft magnetic powder is prepared and is applied to a substrate or the like. Then, the solvent in the applied solution is volatilized by a printing method, whereby a magnetic sheet is obtained. Pressing may also be performed to improve the density of the magnetic sheet.

Compared with a magnetic sheet obtained by a printing method, a magnetic body obtained by compression molding allows the contents of the second large-diameter metal powder and the small-diameter metal powder to be reduced more easily. This is because the relatively soft second large-diameter powder particles and small-diameter powder particles are crushed during compression molding, thereby facilitating an increase in the density of the magnetic body.

The use of the magnetic core of the present disclosure is also not particularly limited. Examples of the application include coil devices (magnetic devices) such as inductors, choke coils, and transformers. Further examples include electronic apparatuses using the magnetic core of the present disclosure, such as DC-DC converters.

### EXAMPLES

Hereinafter, the present disclosure will be described in further detail with reference to the following Examples. However, the present disclosure is not limited to these Examples.

First, a ferrite powder to form ferrite powder particles was prepared. The type and average particle size of the ferrite powder are shown in Table 1. In Sample No. 12, two types of ferrite powders were used.

A first large-diameter metal powder to form first large-diameter powder particles was prepared. Specifically, a permalloy powder having the average particle size shown in Table 1 was prepared. Fine particles were removed as necessary by classification to prevent metal particles having a particle size of less than 1.0 μm from being included.

A second large-diameter metal powder to form second large-diameter powder particles was prepared. Specifically, a carbonyl iron powder having an average particle size of 3 μm was prepared. Fine particles were removed as necessary by classification to prevent metal particles having a particle size of less than 1.0 μm from being included.

A small-diameter metal powder to form small-diameter powder particles was prepared. Specifically, a carbonyl iron powder having an average particle size of 0.8 μm was prepared. Coarse particles were removed as necessary by classification to prevent metal particles having a particle size of 1.0 μm or more from being included.

The first large-diameter ferrite powder, the first large-diameter metal powder, the second large-diameter ferrite powder, the second large-diameter metal powder, and the small-diameter metal powder thus prepared were mixed in accordance with the mixing ratios shown in Table 1 to obtain a soft magnetic powder. In Sample No. 11, carbonyl iron powder alone was used as the large-diameter metal powder. For convenience of presentation, in Table 1, the contents of the first and second large-diameter metal powders are set to 0 wt % and 15 wt %, respectively.

Next, the soft magnetic powder and epoxy resin were kneaded to obtain a resin compound. The content of the epoxy resin was 3 parts by weight based on 100 parts by weight of the soft magnetic powder.

Next, the resin compound was placed in a toroidal mold and was subjected to compression molding to obtain a toroidal molded body. The molded body had an outer diameter of 15 mm, an inner diameter of 9 mm, and a height of 3 mm, and the molding pressure was set to 100 MPa.

Thereafter, the epoxy resin in the obtained molded body was cured by heating to obtain a toroidal core as a magnetic body. The heat treatment was performed at 200° C. for 120 minutes.

Sample Nos. 5 to 7 were prepared using ferrite powders from different production lots.

In addition, the resin compound was placed in a disc-shaped mold and was subjected to compression molding to obtain a disc-shaped molded body. The molded body had a diameter of 10 mm and a thickness of 2 mm. A disc-shaped core was prepared as a magnetic body under the same conditions as those for the toroidal core, except for the above-described conditions.

### (Observation of Cross Section)

The toroidal core of each sample was cut in parallel to the molding direction (height direction) to obtain a cross section, which was observed using a SEM (SU-5000, manufactured by Hitachi High-Tech Corporation). In the cross section of the toroidal core of each Example except for Sample No. 8, the total area ratio of the ferrite powder particles was larger than that of the second large-diameter powder particles. Moreover, in the cross section of the toroidal core of each Example except for Sample No. 11, the total area ratio of the ferrite powder particles was 50% or less.

### (Magnetic Properties)

The initial permeability μi of the toroidal core of each sample was measured. First, a copper wire of 0.70 mm in diameter was wound 20 turns around the toroidal core. The inductance of the toroidal core was measured using an LCR meter under the conditions that the measurement temperature was room temperature (25° C.), the measurement frequency was 100 kHz, and a direct current (DC) of 0.5 mA was applied while superposing a DC magnetic field of 0.4 A/m. Then, the initial permeability μi (unit: H/m) was calculated from the obtained inductance. Results are shown in Table 1. The sample was regarded as good when μi was 25 H/m or more.

The relative permittivity er of the disc-shaped core of each sample was measured. First, a terminal electrode was formed by applying In—Ga paste to each side surface of the disc-shaped magnetic core. Then, capacitance was measured at room temperature (25° C.) using an LCR meter, and the relative permittivity was calculated from the measured capacitance. The measurement frequency was 1 MHz, and the measurement voltage was 0.5 Vrms. Results are shown in Table 1. The sample was regarded as good when εr was 260 or less, as particularly good when er was 180 or less, and as excellent when εr was 100 or less.

The Isat of the toroidal core of each sample was measured to evaluate the DC bias characteristics of each sample. As the applied DC current increased, the toroidal core of each sample showed a decrease in permeability. The value of the DC current when the permeability was reduced from the initial permeability by 10% was defined as Isat. Results are shown in Table 1. The sample was regarded as good when Isat was 2.4 A or more and as particularly good when Isat was 3.0 A or more.

TABLE 1

| | | | | | | | | | | Second Large- | | Small- | | | | |
|---|---|---|---|---|---|---|---|---|---|---|---|---|---|---|---|---|
| | | | | | | | | First Large- | | Diameter | | Diameter | | | | |
| | | First Large- | | | Second Large- | | | Diameter | | Metal Powder | | Metal Powder | | | | |
| | | Diameter | | | Diameter | | | Metal Powder | | (Carbonyl | | (Carbonyl | | | | |
| | | Ferrite Powder | | | Ferrite Powder | | | (Permalloy Powder) | | Iron Powder) | | Iron Powder) | | | | |
| | | | Aver- | | | Aver- | | Aver- | | Aver- | | Aver- | | | | |
| | | | age | | | age | | age | | age | | age | | | | |
| | Example/ | | Par- | Mix- | | Par- | Mix- | Par- | Mix- | Par- | Mix- | Par- | Mix- | Magnetic | | |
| | Compar- | | ticle | ing | | ticle | ing | ticle | ing | ticle | ing | ticle | ing | Properties | | |
| Sample | ative | | Size | Ratio | | Size | Ratio | Size | Ratio | Size | Ratio | Size | Ratio | μi | | Isat |
| No. | Example | Type | (μm) | (wt %) | Type | (μm) | (wt %) | (μm) | (wt %) | (μm) | (wt %) | (μm) | (wt %) | (H/m) | εr | (A) |
| 1 | Compar- | — | — | 0 | — | — | 0 | 24 | 80 | 3 | 10 | 0.8 | 10 | 56 | 300 | 5.5 |
| | ative | | | | | | | | | | | | | | | |
| | Example | | | | | | | | | | | | | | | |
| 2 | Compar- | Mn | 4 | 10 | — | — | 0 | 24 | 70 | 3 | 10 | 0.8 | 10 | 46 | 419 | 6.4 |
| | ative | | | | | | | | | | | | | | | |
| | Example | | | | | | | | | | | | | | | |
| 3 | Compar- | Mn | 4 | 20 | — | — | 0 | 24 | 60 | 3 | 10 | 0.8 | 10 | 39 | 570 | 4.8 |
| | ative | | | | | | | | | | | | | | | |
| | Example | | | | | | | | | | | | | | | |
| 4 | Compar- | Mn | 4 | 30 | — | — | 0 | 24 | 50 | 3 | 10 | 0.8 | 10 | 34 | 739 | 4.2 |
| | ative | | | | | | | | | | | | | | | |
| | Example | | | | | | | | | | | | | | | |
| 5 | Example | Ni | 30 | 40 | — | — | 0 | 24 | 40 | 3 | 10 | 0.8 | 10 | 33 | 54 | 4.6 |
| 6 | Example | Ni | 30 | 40 | — | — | 0 | 24 | 40 | 3 | 10 | 0.8 | 10 | 29 | 63 | 5.2 |
| 7 | Example | Ni | 30 | 40 | — | — | 0 | 24 | 40 | 3 | 10 | 0.8 | 10 | 33 | 87 | 3.3 |
| 8 | Example | Ni | 8 | 10 | — | — | 0 | 24 | 70 | 3 | 10 | 0.8 | 10 | 46 | 256 | 6.4 |
| 9 | Example | Ni | 8 | 20 | — | — | 0 | 24 | 60 | 3 | 10 | 0.8 | 10 | 38 | 169 | 4.6 |
| 10 | Example | Ni | 8 | 30 | — | — | 0 | 24 | 50 | 3 | 10 | 0.8 | 10 | 35 | 114 | 3.5 |
| 11 | Example | Ni | 30 | 70 | — | — | 0 | — | 0 | 3 | 15 | 0.8 | 15 | 36 | 21 | 2.4 |
| 12 | Compar- | Ni | 30 | 70 | Ni | 3 | 15 | — | 0 | — | 0 | 0.8 | 15 | 18 | 18 | 1.6 |
| | ative | | | | | | | | | | | | | | | |
| | Example | | | | | | | | | | | | | | | |
| 13 | Example | Ni | 30 | 35 | — | — | 0 | 24 | 40 | 3 | 7.5 | 0.8 | 17.5 | 38 | 108 | 3.6 |
| 14 | Example | Ni | 30 | 35 | — | — | 0 | 24 | 40 | 3 | 12.5 | 0.8 | 12.5 | 35 | 91 | 3.9 |
| 15 | Example | Ni | 30 | 37.5 | — | — | 0 | 24 | 37.5 | 3 | 12.5 | 0.8 | 12.5 | 37 | 80 | 4.0 |
| 16 | Example | Ni | 30 | 40 | — | — | 0 | 24 | 35 | 3 | 12.5 | 0.8 | 12.5 | 32 | 68 | 4.4 |
| 17 | Example | Ni | 30 | 40 | — | — | 0 | 24 | 35 | 3 | 17.5 | 0.8 | 7.5 | 30 | 71 | 4.2 |
| 18 | Example | Ni | 30 | 50 | — | — | 0 | 24 | 30 | 3 | 10 | 0.8 | 10 | 26 | 52 | 3.7 |
| 19 | Compar- | — | — | 0 | — | — | 0 | 18 | 80 | 3 | 10 | 0.8 | 10 | 30 | 289 | 8.3 |
| | ative | | | | | | | | | | | | | | | |
| | Example | | | | | | | | | | | | | | | |
| 20 | Example | Ni | 30 | 40 | — | — | 0 | 18 | 40 | 3 | 10 | 0.8 | 10 | 42 | 194 | 4.8 |

As shown in Table 1, the magnetic core of each Example having a structure and composition in which the ferrite powder particles, the large-diameter powder particles, and the small-diameter powder particles were each in the predetermined range exhibited preferable initial permeability and DC bias characteristics as well as low permittivity.

On the other hand, Sample Nos. 1 and 19 which did not include the ferrite powder exhibited excessively high permittivity. Sample Nos. 2 to 4 in which the ferrite powder was not the Ni-based ferrite powder exhibited excessively high permittivity. In Sample No. 12 which did not include the large-diameter metal powder, the permeability decreased, and the DC bias characteristics deteriorated.

### REFERENCE SIGNS LIST

1 . . . magnetic body
11 . . . ferrite powder particles
13 . . . metal powder particles
13a . . . first large-diameter powder particles
13b . . . second large-diameter powder particles
13c . . . small-diameter powder particles

1. A soft magnetic powder comprising:
a large-diameter metal powder;
a small-diameter metal powder; and
a ferrite powder,
wherein the large-diameter metal powder includes large-diameter powder particles having a particle size of 1.0 μm or more,
the small-diameter metal powder includes small-diameter powder particles having a particle size of less than 1.0 μm,
the ferrite powder includes ferrite powder particles having a particle size of 1.0 μm or more, and
the ferrite powder comprises a Ni-based ferrite powder.

2. The soft magnetic powder according to claim 1, wherein the average particle size of the ferrite powder particles is larger than that of the large-diameter powder particles.

3. The soft magnetic powder according to claim 1, wherein the large-diameter metal powder includes a first large-diameter metal powder and a second large-diameter metal powder, and the average particle size of first large-diameter powder particles included in the first large-diameter metal powder is larger than that of second large-diameter powder particles included in the second large-diameter metal powder.

4. The soft magnetic powder according to claim 3, wherein the average particle size of the ferrite powder particles is larger than that of the first large-diameter powder particles.

5. The soft magnetic powder according to claim 3, wherein the content of the ferrite powder is larger than that of the second large-diameter metal powder on a weight basis.

6. The soft magnetic powder according to claim 5, wherein the content of the ferrite powder is 50 wt % or less.

7. A magnetic body comprising:
a large-diameter metal powder;
a small-diameter metal powder; and
a ferrite powder,
wherein the large-diameter metal powder includes large-diameter powder particles having a particle size of 1.0 μm or more,
the small-diameter metal powder includes small-diameter powder particles having a particle size of less than 1.0 μm,
the ferrite powder includes ferrite powder particles having a particle size of 1.0 μm or more, and
the ferrite powder includes a Ni-based ferrite powder.

8. The magnetic body according to claim 7, wherein the average particle size of the ferrite powder particles is larger than that of the large-diameter powder particles.

9. The magnetic body according to claim 7, wherein the large-diameter metal powder includes a first large-diameter metal powder and a second large-diameter metal powder, and the average particle size of first large-diameter powder particles included in the first large-diameter metal powder is larger than that of second large-diameter powder particles included in the second large-diameter metal powder.

10. The magnetic body according to claim 9, wherein the average particle size of the ferrite powder particles is larger than that of the first large-diameter powder particles.

11. The magnetic body according to claim 9, wherein the total area ratio of the ferrite powder particles is larger than that of the second large-diameter powder particles in a cross section of the magnetic body.

12. The magnetic body according to claim 11, wherein the total area ratio of the ferrite powder particles is 50 wt % or less.

13. A coil device comprising the soft magnetic powder according to claim 1.

14. A coil device comprising the magnetic body according to claim 7.
